(19) United States
(12) Patent Application Publication
(10) Pub. No.: US 2019/0391794 A1
(43) Pub. Date: Dec. 26, 2019

(54) SYSTEM FOR DEVELOPING A PROGRAM INTENDED TO COMMUNICATE WITH A SET OF AT LEAST ONE DATABASE

(71) Applicant: BULL SAS, Les Clayes-sous-Bois (FR)

(72) Inventor: Daniel AVAKIANTZ, Buc (FR)

(21) Appl. No.: 16/452,119

(22) Filed: Jun. 25, 2019

(30) Foreign Application Priority Data
Jun. 26, 2018 (FR) 1855694

(51) Int. Cl. G06F 8/41; G06F 16/23; G06F 16/245

(52) U.S. Cl. CPC G06F 8/443; G06F 16/245; G06F 16/2358

(57) ABSTRACT

A system includes an interface; a software library; a pre-compiler adapted to replace each embedded SQL instruction with replacement code in COBOL language including a call to a routine of the software library passing to the routine an instruction issuing from the embedded SQL instruction. The routine is adapted to send to the interface a message including the instruction issuing from the embedded SQL instruction. The interface is a server intended to be connected to a computer network to which the computer device is connected and the routine of which is a client, the interface being designed to relay, as a SQL instruction, the instruction of at least one of the received message(s) to at least one database in the set.

### CROSS-REFERENCE TO RELATED APPLICATIONS

This application claims priority to French Patent Application No. 1855694, filed on Jun. 26, 2018, the entire content of which is incorporated herein by reference in its entirety.

### FIELD

The present invention relates to a system for developing a program intended to communicate with a set of at least one database.

### BACKGROUND

The company MICROFOCUS sells for example a software suite comprising a COBOL compiler and a pre-compiler (also called a “processor”) called OpenESQL. The pre-compiler is designed to replace each embedded SQL instruction with replacement code in COBOL language intended to communicate with a Java program executed in a Java virtual machine and connected to one or more databases.

One problem with this software suite is that it is necessary to develop a Java program for each program in COBOL language.

Moreover, US patent application published under number US 2003/041052 A1 discloses a system comprising a client coupled to a server via a network. The server comprises a database management system (DBMS) that communicates with a database. The client comprises a program that comprises a conversion tool designed to convert SQL instructions according to ODBC (from “Open DataBase Connectivity”) standard. During this conversion, a SQL instruction may be replaced by a call to a library function that performs calls to an ODBC library.

A problem of system in document US 2003/041052 A1 is that the client's COBOL program uses the ODBC library as an interface to access the database. Yet, the ODBC library is accessed by calls such that each program must have its own copy (instance) of the ODBC library. This makes the program development more complex.

### SUMMARY

It may be desired to provide a system for developing a program intended to communicate with a set of at least one database at least partly overcoming the aforementioned problems.

The subject matter of the invention is therefore a system for developing a program intended to communicate with a set of at least one database, each designed to receive SQL instructions, comprising:
an interface intended to be connected to each database in the set,
a software library,
a pre-compiler designed to analyse a source code comprising main code in COBOL language and at least one embedded SQL instruction, and to replace each embedded SQL instruction with replacement code in COBOL language comprising a call to a routine of the software library passing to the routine an instruction issuing from the embedded SQL instruction, in order to provide a pre-compiled source code,
wherein the pre-compiled source code is intended to be compiled by a compiler in order to provide an executable program comprising the call or calls to the routine, wherein the executable program and the called routine are intended to be executed by a computer device,
wherein the called routine is designed to send to the interface a message comprising the instruction passed with the call, and
wherein the interface is a server intended to be connected to a computer network to which the computer device is connected and the routine of which is a client, the interface being designed to relay, as an SQL instruction, the instruction of at least one of the received message or messages to at least one database in the set.

The interface can thus be used by a plurality of clients. It is therefore reusable by each computer program in COBOL language developed by means of the system according to the invention. This makes the development of each of these computer programs easier since developers don't need to have the interface during the computer program's development, but simply the library comprising the routine according to the invention. Furthermore, if there is a need for modifying the interface (for example to support new types of databases), this is made in a transparent way for the computer programs that keep on using the routine communicating according to the client-server mode with the modified interface.

Optionally, the interface is designed to:
hold a list of the database or databases in the set to each of which the interface has relayed an instruction of one of the message or messages received from the routine, requesting access to this database,
analyse each message received from the routine in order to determine whether the instruction of this message is a predefined instruction, and
if the instruction of this message is the predefined instruction, implement a procedure of logging of the database or databases in the list.

Optionally also, the logging procedure comprises:
the sending, to each database in the list, of a first SQL instruction requesting the preparation of a logging,
the reception, from each database in the list, of a response indicating that this database is ready to implement the logging,
following the reception of the responses from all the databases in the list, the sending, to each database in the list, of a second SQL instruction requesting implementing of the logging.

Optionally also, the interface is designed to:
analyse each message received from the routine and determine whether this message comprises, in addition to the instruction, a number representing a maximum number of results,
relay, as an SQL instruction, the instruction of the received message to a database in the set,
receive from this database a response to the SQL instruction comprising results,
filter the results in order to keep only the maximum number of results, and
send to the routine, in place of the response received, a replacement response comprising solely the filtered results.

Optionally also, the results of the response are classified in a certain order, and the results kept are the first ones in this order.

Optionally also, the interface is a program intended to be executed by a computer device connected to the computer network, different from the computer device that executes the program and the called routine.

Optionally also, the interface is a program intended to be executed in a Java virtual machine.

Optionally also, the program forming the interface is designed to communicate with each database in the set through the JDBC software library.

Optionally also, the pre-compiler is also designed to:
seek, in the embedded SQL instruction or instructions, an expression comprising:
   a main variable intended to contain a string of characters,
   an indicator variable intended to contain an integer number, and
   one or more predefined characters associating the main and indicator variables, and
replace each expression found with code in COBOL language supplying the first N characters of the first variable, N being the value of the indicator variable.

Optionally also, the pre-compiler is also designed to, before the search in the embedded SQL instruction or instructions for the expression:
seek, in the embedded SQL instruction or instructions, a variable defined in the code in COBOL language as being of variable length,
replace each variable of variable length found with an indicator variable expression comprising:
   a main variable intended to contain a character string,
   an indicator variable intended to contain an integer number, and
   the predefined character or characters associating the main and indicator variables.

### BRIEF DESCRIPTION OF THE DRAWINGS

The invention will be understood best by means of the following description, given solely by way of example and made with reference to the accompanying drawings, in which:

FIG. 1 shows schematically the general structure of a computer installation, according to an embodiment of the invention, and

FIG. 2 illustrates the successive steps of a method for developing and using a program intended to communicate with a set of databases, according to an embodiment of the invention.

### DETAILED DESCRIPTION

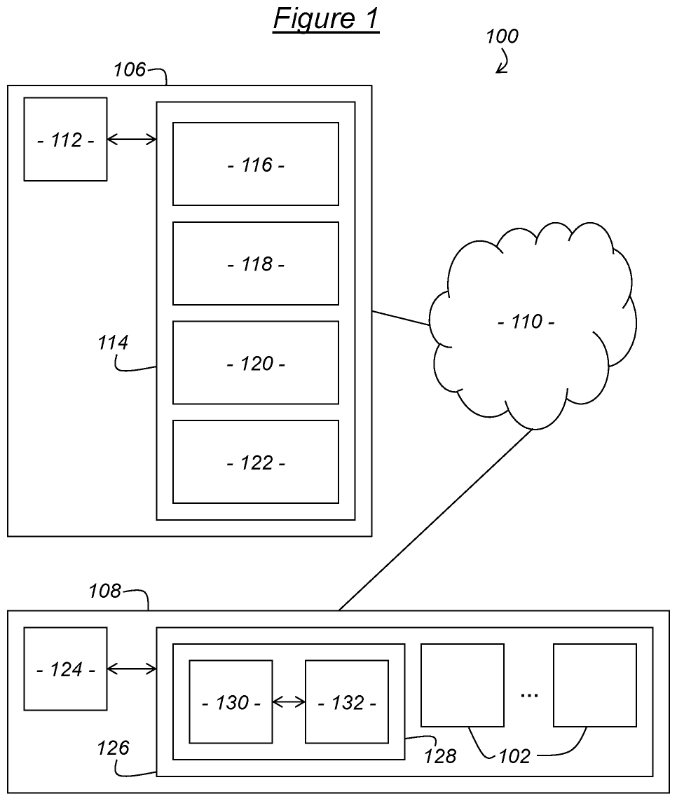

With reference to FIG. 1, a computer installation 100 implementing the invention will now be described.

The computer installation 100 comprises a set of at least one database, designated individually and collectively by the reference 102, and a system for communicating with the database or databases 102.

In the present description, the term “database” encompasses not only the computer structure containing the data, but also the database management system for manipulating this structure.

Each database 102 is designed to receive SQL (from “Structured Query Language”) instructions. Each database is for example one of the following types: PostgreSQL, Oracle, MySQL, SQL Server, DB2.

The system for communicating with the database or databases 102 comprises first and second computer devices 106, 108, as well as a computer network 110 to which the first and second computer devices 106, 108 are connected, to enable them to exchange data. The computer network 110 is for example a TCP/IP network. In particular, the first and second computer devices 106, 108 have respective addresses in this computer network 110.

The first computer device 106 comprises a central processing unit 112, such as a microprocessor, and a memory 114 in which a source code 116, a software library 118 comprising at least one routine, referred to as a communication routine, a pre-compiler 120 (also called a “pre-processor”) and a compiler 122 are recorded.

The source code 116 comprises code in COBOL language and at least one embedded SQL instruction. Each embedded SQL instruction is intended to generate an SQL instruction transmitted to at least one database 102 in the set. In the simplest case, the SQL instruction is identical to the embedded SQL instruction.

The pre-compiler 120 is for example written in C language and can be used on any computer device comprising a COBOL compiler.

In the example described, the first computer device 106 is a mainframe computer using an operating system in the GCOS (from “General Comprehensive Operating System”) family, for example the GCOS 7 operating system.

The second computer device 108 comprises a central processing unit 124, such as a microprocessor, and a memory 126 in which a virtual machine 128, (a Java virtual machine in the example described), an interface 130 intended to be executed in the virtual machine 128, and a software library 132 also intended to be executed in the virtual machine 128, when called by the interface 130, are recorded. The interface 130 is thus written in Java language and uses the software library 132 (in the example described, the JDBC for “Java Database Connectivity” library) to connect to and communicate with each database 102 in the set. The interface 130 is a server, the communication routine of which is a client.

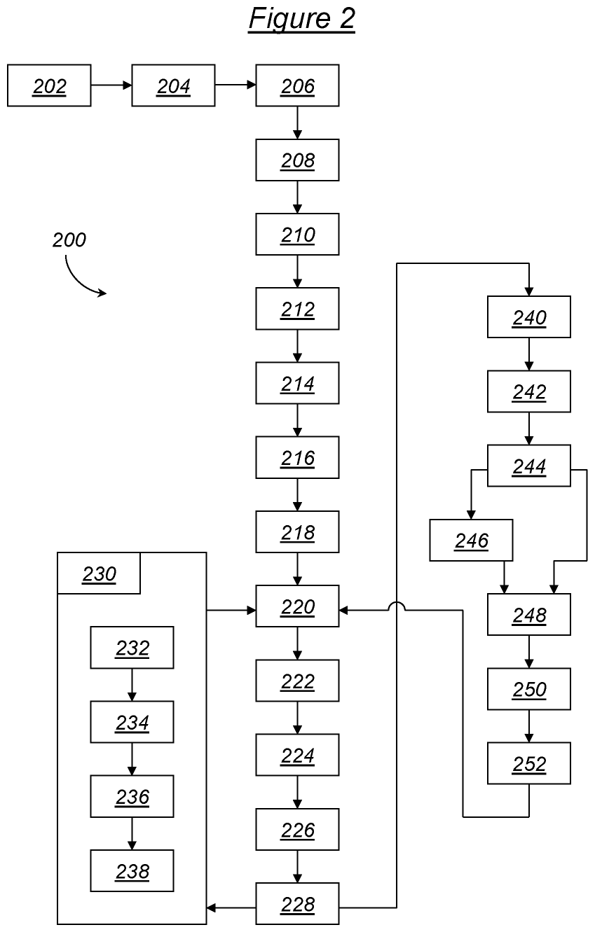

With reference to FIG. 2, a method 200 for developing and using a program intended to communicate with the set of database(s) 102 will now be described.

During a step 202, the pre-compiler 120 obtains the source code 116 comprising the embedded SQL instruction or instructions. Each embedded SQL instruction is for example located in the source code 116 by means of at least one predefined expression. For example, each embedded SQL instruction is placed between a start predefined expression (“EXEC SQL” in the example described) and an end predefined expression (“END-EXEC” in the example described).

In a first example, the code in COBOL language of the source code 116 comprises the definition of two variables NAME and ADDRESS (belonging in the example described to a structure called SHOP):

| | |
|---|---|
| 01 SHOP. | |
| 02 NAME | PIC X(32) VARYING. |
| 02 ADDRESS | PIC X(40) VARYING. |

Furthermore, the source code 116 further comprises the embedded SQL instruction:

### EXEC SQL

UPDATE_SHOPS_SET_ADDRESS=:ADDRESS

WHERE_NAME_=:NAME

### END-EXEC.

using the two variables NAME and ADDRESS.

In this first example, the variables NAME and ADDRESS are defined as being of variable length because of the presence of a predefined key word (“VARYING”) at the end of the definition.

In a second example, the source code 116 comprises the following embedded SQL instruction:

EXEC SQL
AT MYDB ALTER TABLE SHOPS ADD SHOP_NAME CHAR(10)

END-EXEC.

This embedded SQL instruction requests adding a column SHOP_NAME, the elements of which may comprise up to ten characters, to the SHOPS table in the MYDB database.

In a third example, the source code 116 comprises the following embedded SQL instruction:

EXEC SQL
FOR :NB-ROW AT MYDB SELECT SHOP_NAME, SHOP_TOWN INTO :SHOP-NAME-T, :SHOP-TOWN-T FROM SHOPS

END-EXEC.

This embedded SQL instruction requires selecting the elements the columns SHOP_NAME and SHOP_TOWN from the SHOPS table of the MYDB database, limiting the results to the number NB-ROW and recording the response in the variables SHOP-NAME-T and SHOP-TOWN-T. The variables NB-ROW, SHOP-NAME-T and SHOP-TOWN-T are variables defined in the COBOL language part of the source code 116, apart from the embedded SQL instruction, as indicated by the two points “:” preceding them.

In a fourth example, the source code 116 comprises the following embedded SQL instruction:

EXEC SQL
COMMIT ALL

END-EXEC

As will be explained hereinafter, this fourth embedded SQL instruction aims to produce a logging of at least one database 102 in the set.

During a step 204, the pre-compiler 120 analyses the source code 116 in order to seek an embedded SQL instruction. In the example described, the pre-compiler 120 seeks the pair of predefined start and end expressions and deduces from this that the code placed between them is an embedded SQL instruction.

During a step 206, the pre-compiler 120 seeks a definition of a variable of variable length used in at least one embedded SQL instruction found. In the example described, the pre-compiler 120 detects the presence of the predefined key word (“VARYING”) in the definition of a variable in order to determine that this variable is of variable length.

In the aforementioned first example, the pre-compiler 120 therefore finds the definition of the variable NAME and the definition of the variable ADDRESS.

During a step 208, the pre-compiler 120 replaces, in the code in COBOL language, each definition of each variable of variable length found by two definitions of respectively two variables: a first so-called main variable intended to contain a string of characters and a second so-called indicator variable intended to contain an integer number representing the length used of the main variable. For example, if the main variable is a character string of 32 characters and contains a 10-character word followed by 22 spaces, the indicator variable will contain the number 10.

Thus, in the aforementioned first example, the definitions of the variables NAME and ADDRESS in the code in COBOL language are replaced by the following definitions:

| | |
|---|---|
| 01 SHOP. | |
| 02 NAME. | |
| 49 NAME-LEN | COMP-2. |
| 49 NAME-ARR | PIC X(32) |
| 02 ADDRESS. | |
| 49 ADDRESS-LEN | COMP-2. |
| 49 ADDRESS-ARR | PIC X(40) |

Still during step 208, the pre-compiler 120 further replaces, in each embedded SQL instruction using it, each variable of variable length found by an indicator variable expression comprising the associated main and indicator variables and one or more predefined characters associating the main and indicator variables. The indicator variable expression is for example of the form A:B, where A is the main variable and B the indicator variable.

Thus, in the aforementioned first example, the variables NAME and ADDRESS are replaced respectively by NAME-ARR:NAME-LEN and ADDRESS-ARR:ADDRESS-LEN, so that the embedded SQL instruction becomes:

### EXEC SQL

UPDATE_SHOPS_SET_ADDRESS=:ADDRESS-ARR:ADDRESS-LEN

WHERE_NAME_=:NAME-ARR:NAME-LEN

### END-EXEC.

During a step 210, the pre-compiler 120 once again analyses the source code 116 as modified at step 208 in order to seek an indicator variable expression in the embedded SQL instruction or instructions.

During a step 212, the pre-compiler 120 replaces each indicator variable expression found with a replacement expression in COBOL language supplying the first N characters of the main variable, N being the value of the indicator variable. In the example described, the replacement expression is A(1:B) where A is the main variable and B the indicator variable.

Thus, in the aforementioned first example, the expression ADDRESS-ARR:ADDRESS-LEN is replaced by the expression ADDRESS-ARR(1:ADDRESS-LEN) and the expression NAME-ARR:NAME-LEN is replaced by the expression NAME-ARR(1:NAME-LEN), so that the embedded SQL instruction becomes: EXEC SQL

UPDATE_SHOPS_SET_ADDRESS_=:ADDRESS-ARR(1:ADDRESS-LEN)

WHERE_NAME_=:NAME-ARR(1:NAME-LEN)

### END-EXEC.

Thus the pre-compiler 120 enables the developer writing the source code 116 to use, as required, either directly expressions of indicator variables in the embedded SQL instructions (processed in steps 210 and 212), or, in the embedded SQL instructions, variables of variable length (processed at step 206 and 208, and then at step 210 and 212). Thus the pre-compiler 120 offers flexibility of design to the developer.

Thus, the first N characters contained in the main variable are sent to the database, instead of the expression of predefined form comprising the indicator variable, such that any database can understand what is sent. In other words, the interpretation of the expression of predefined form and the processing of the character string of the main variable which results from this interpretation, that were previously performed in the database, are, in the invention, performed by the computer program that sends the result, such that the database doesn't need to be designed to perform this interpretation and this processing.

During a step 214, the pre-compiler 120 replaces each embedded SQL instruction found (as well as the predefined start and end expressions surrounding it) with replacement code in COBOL language.

The replacement code comprises first of all a first part defining a data structure, called SQL-IO-PARAMETERS in the example described. The data structure SQL-IO-PARAMETERS comprises a first variable, called SQL-REQUEST in the example described, of the character string type and intended to contain an instruction issuing from the embedded SQL instruction. The data structure SQL-IO-PARAMETERS further comprises a second variable, called SQL-FOR-VALUE in the example described, intended to contain an argument of a FOR clause of the embedded SQL instruction. The data structure SQL-IO-PARAMETERS further comprises a third variable, called SQL-AT-VALUE in the example described, intended to contain an argument of an AT clause of the embedded SQL instruction.

The replacement code further comprises a second part intended to deduce an instruction from the embedded SQL instruction and to record this deduced instruction in the variable SQL-REQUEST. In the example described, the deduced instruction corresponds to the embedded SQL instruction without the FOR, AT and INTO clauses. It will be appreciated that, in the example described, if the embedded SQL instruction does not contain a FOR, AT or INTO clause, the deduced instruction is identical to the embedded SQL instruction.

In the aforementioned first example, the second part of the replacement code is:

### STRING

“UPDATE_SHOPS SET_ADDRESS=”

ADDRESS-ARR(1:ADDRESS-LEN) “WHERE_NAME=”

NAME-ARR(1:NAME-LEN)

DELIMITED BY SIZE INTO SQL-REQUEST

### END-STRING,

Thus the instruction SQL: UPDATE_SHOPS SET_ADDRESS=ADDRESS-ARR(1:ADDRESS-LEN) WHERE_NAME=NAME-ARR(1:NAME-LEN) is recorded in the variable SQL-REQUEST.

In the aforementioned second example, the second part of the replacement code is:

STRING
“ALTER TABLE SHOPS ADD SHOP_NAME CHAR(10)”
DELIMITED BY SIZE INTO SQL-REQUEST

END-STRING,

Thus the instruction SQL: ALTER TABLE SHOPS ADD SHOP_NAME CHAR(10) is recorded in the variable SQL-REQUEST.

In the aforementioned third example, the second part of the replacement code is:

STRING
“SELECT SHOP_NAME, SHOP_TOWN ”
“FROM SHOPS”
DELIMITED BY SIZE INTO SQL-REQUEST

END-STRING,

Thus the instruction SQL: SELECT SHOP_NAME, SHOP_TOWN FROM SHOPS is recorded in the variable SQL-REQUEST.

In the aforementioned fourth example, the second part of the replacement code is:

STRING
“COMMIT ALL”
DELIMITED BY SIZE INTO SQL-REQUEST

END-STRING,

Thus the instruction SQL: COMMIT ALL is recorded in the variable SQL-REQUEST.

The replacement code further comprises a third part intended to record the arguments of the FOR and AT clauses in the respective variables SQL-FOR-VALUE and SQL-AT-VALUE.

In the aforementioned first and fourth examples, the third part of the replacement code is empty since there is no FOR clause or AT clause.

In the aforementioned second example, the third part of the replacement code is:

MOVE “MYDB” TO SQL-AT-VALUE,

In the aforementioned third example, the third part of the replacement code is:

MOVE NB-ROW TO SQL-FOR-VALUE,

MOVE “MYDB” TO SQL-AT-VALUE,

The replacement code further comprises a fourth part comprising a call to the communication routine of the software library 118 passing the variable SQL-REQUEST in which the extracted instruction is recorded and the variables SQL-FOR-VALUE and SQL-AT-VALUE in which, where applicable, the arguments of the FOR and AT clauses are recorded.

In the example described, the structure SQL-IO-PARAMETERS is passed to the call of the communication routine in order to pass the variables SQL-REQUEST, SQL-FOR-VALUE and SQL-AT-VALUE.

In the aforementioned four examples, the fourth part of the replacement code is as follows (the communication routine having, in the example described, the name SQL-CALL):

CALL “SQL-CALL” USING SQL-IO-PARAMETERS,

If an INTO clause is present in the embedded SQL instruction, the replacement code further comprises a fifth part intended to record a response to the embedded SQL instruction in the variables indicated by the INTO clause.

Thus, in the aforementioned first, second and fourth examples, there is no INTO clause, so that the replacement code does not comprise the fifth part.

In the aforementioned third example, the fifth part of the replacement code is intended to record the results for the SHOP_NAME column in the variable SHOP-NAME-T and the results for the SHOP_TOWN column in the variable SHOP-TOWN-T.

During a step 216, the pre-compiler 120 supplies a pre-compiled source code that is entirely in COBOL language.

During a step 218, the compiler 122 compiles the pre-compiled source code in order to supply an executable program composed of machine code. This executable program comprises in particular the call or calls to the communication routine of the software library 118 that have replaced the embedded SQL instruction or instructions.

During a step 220, the first computer device 106 executes the executable program.

During a step 222, the first computer device 106 reaches, in the executable program, the machine code issuing from the compilation of the replacement code of an embedded SQL instruction. Thus, in particular, the communication routine (the fourth part of the replacement code) is called and the deduced instruction is passed as well as, where applicable, the arguments of the FOR and AT clauses (contained in the variables SQL-FOR-VALUE and SQL-AT-VALUE).

During a step 224, the communication routine sends to the interface 130, via the computer network 110, a message containing the deduced instruction and, where applicable, the arguments of the FOR and AT clauses. Thus the message is sent to the address of the interface 130 in the computer network 110.

During a step 226, the interface 130 receives the message sent by the communication routine and analyses it.

During a step 228, the interface 130 determines whether the deduced instruction contained in the received message is the predefined instruction: COMMIT ALL. If such is the case, the method 200 passes to step 230, otherwise it passes to step 240.

During a step 230, the interface 130 intercepts the deduced instruction contained in the received message and implements a procedure of logging the database or databases 102 belonging to a list kept up to date by the interface 130 and listing the database or databases to which the executable program has gained access. A database 102 to which the executable program has gained access is a database 102 to which the interface 130 has transmitted at least one SQL instruction issuing from an embedded SQL instruction that was replaced in the source code of the executable program. In the example described, the logging procedure comprises steps 232 to 238.

During a step 232, the interface 130 sends, to each database 102 in the list, a first replacement SQL instruction requesting the preparation of a logging. In the example described, the first replacement SQL instruction is the SQL instruction: PREPARE TO COMMIT.

During a step 234, each database 102 in the list receives the first SQL instruction, prepares for the logging and sends a response indicating that this database 102 is ready to implement the logging.

During a step 236, the interface 130 receives, from each database 102 in the list, the response indicating that this database 102 is ready to implement the logging.

During a step 238, following the reception of the responses from all the databases 102 in the list, the interface 130 sends, to each database 102 in the list, a second replacement SQL instruction requesting implementation of the logging. In the example described, the second replacement SQL instruction is the instruction SQL: COMMIT. The method 200 then returns to step 220.

During a step 240, the interface 130 determines whether the received message comprises, in addition to the deduced instruction that it contains, a variable containing an argument of a FOR clause.

During a step 242, the interface 130 relays, as a SQL instruction, the deduced instruction contained in the message received to the database 102 indicated by the argument of the AT clause.

During a step 244, this database 102 receives the SQL instruction, processes it and, where applicable, sends to the interface 130 a response to the SQL instruction comprising results classified in a certain order.

If the interface 130 has at step 240 determined that the received message comprises, in addition to the extracted instruction, an argument of a FOR clause, then the method 200 passes to the following step 246. Otherwise it passes to step 248.

During a step 246, the interface 130 intercepts the response to the SQL instruction, filters the results in order to keep only the maximum number indicated by the argument of the FOR clause, and sends to the communication routine, in place of the intercepted response, a replacement response comprising solely the filtered results. The results kept are the first ones in the classification order. The method 200 then passes to step 248.

During a step 248, the interface 130 relays the response (with all the results or only a part depending on whether step 246 was executed or not) to the communication routine.

During a step 250, the communication routine receives the response and makes it available to the program.

During a step 252, where applicable, machine code corresponding to the fifth part of the replacement code is executed so that the program once again calls the communication routine so that the latter allocates the response to the variables indicated by the INTO clause. The method 200 then returns to step 220.

It is clear that the pre-compiler 120 makes it possible to use the indicator variables for any type of database.

It should also be noted that the invention is not limited to the embodiments described above. It will in fact be clear to a person skilled in the art that various modifications can be made to the embodiments described above, in the light of the teaching that has just been disclosed to them.

For example, the pre-compilation and the compilation could be carried out on a computer device other than the first computer device 106. The executable program obtained and the software library 118 would then be recorded in the memory 114 of the first computer device 106 in order to be executed.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium (e.g. a memory) is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “programmed processor” encompasses all kinds of apparatus, devices, and machines for processing data, including by way of example a programmable processor, digital signal processor (DSP), a computer, a system on a chip, or multiple ones, or combinations, of the foregoing. The apparatus can include special purpose logic circuitry, e.g., an FPGA (field programmable gate array) or an ASIC (application-specific integrated circuit).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry. To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In the detailed presentation of the invention given above, the terms used must not be interpreted as limiting the invention to the embodiments disclosed in the present description but must be interpreted so as to include therein all the equivalents the prediction of which is within the capability of a person skilled in the art applying their general knowledge to the implementation of the teaching that has just been disclosed to them.

1. A development and interfacing IT system for executing a computer program, comprising:
a pre-compiler adapted to:
analyse a source code comprising main code in COBOL language and at least one embedded SQL instruction, and
replace each embedded SQL instruction with replacement code in COBOL language comprising a call to a routine, wherein this call passes to the routine a SQLinstruction deduced from the embedded SQL instruction, in order to provide a pre-compiled source code,
a compiler adapted to compile the pre-compiled source code in order to provide the computer program,
a software library comprising the called routine, wherein the latter is designed to send a message that includes the deduced SQL instruction,
an interface adapted to receive the message and relay the deduced SQL instruction included in the received message to a database in a set of at least one database,
wherein:
the interface is a server intended to be connected, via a computer network, to a computer device for executing the computer program and each call to the routine that it includes, and
the routine is a client of this server.

2. The system according to claim 1, wherein the interface is adapted to:
hold a list of the database or databases in the set to each of which the interface has relayed an instruction of one of the message or messages received from the routine, requesting access to this database,
analyse each message received from the routine in order to determine whether the deduced SQL instruction of this message is a predefined instruction, and
if the instruction of this message is the predefined instruction, implement a procedure of logging of the database or databases in the list.

3. The system according to claim 2, wherein the logging procedure comprises:
the sending, to each database in the list, of a first SQL instruction requesting the preparation of a logging,
the reception, from each database in the list, of a response indicating that this database is ready to implement the logging,
following the reception of the responses from all the databases in the list, the sending, to each database in the list, of a second SQL instruction requesting implementing of the logging.

4. The system according to claim 1, wherein the interface is adapted to:
analyse each message received from the routine and determine whether this message comprises, in addition to the deduced SQL instruction, a number representing a maximum number of results,
after having relayed the deduced SQL instruction of the received message to a database in the set, receive from this database a response to the deduced SQL instruction comprising results,
filter the results in order to keep only the maximum number of results, and
send to the routine, in place of the response received, a replacement response comprising solely the filtered results.

5. The system according to claim 4, wherein the results of the response are classified in a certain order, and wherein the results kept are the first ones according to this order.

6. The system according to claim 1, wherein the interface is a program intended to be executed by a computer device connected to the computer network, different from the computer device that executes the program and the called routine.

7. The system according to claim 1, wherein the interface is a program intended to be executed in a Java virtual machine.

8. The system according to claim 7, wherein the program forming the interface is designed to communicate with each database in the set through the JDBC software library.

9. The system according to claim 1, wherein the pre-compiler is also adapted to:
seek, in each embedded SQL instruction, an expression of predefined form, comprising:
a first variable, called main variable, defined in the main code to contain a string of characters,
a second variable, called indicator variable, defined in the main code to contain an integer number N indicating the number of first characters contained in the main variable that are to be used by the database, and
one or more predefined characters associating the main and indicator variables, and
replace each expression of predefined form found with code in COBOL language designed for, when it is compiled by a compiler and executed by a computer, supplying the first N characters contained in its main variable, such that these first N characters replace, in the deduced instruction sent to the database, the found expression of predefined form.

10. The system according to claim 9, wherein the pre-compiler is further adapted to, before the search of the expression of predefined form in each embedded SQL instruction:
seek, in the main code, a definition of a variable of variable length
used in at least one embedded instruction, and for a variable of variable length a definition of which has been found:
replace the definition found by:
a definition of a main variable intended to contain a character string, and
a definition of an indicator variable intended to contain an integer number that indicates the number of first characters contained in the main variable that are to be used by the database,
replace, in each embedded SQL instruction, the variable of variable length with the expression of predefined form comprising:
the main variable defined for this variable of variable length,
the indicator variable defined for this variable of variable length, and
the predefined character or characters associating the main and indicator variables.
